(19) United States
(12) Patent Application Publication
(10) Pub. No.: US 2012/0016707 A1
(43) Pub. Date: Jan. 19, 2012

(54) System and Method for Supplier and Customer Management of Technical and Regulatory Requirements in Procurement Standards

(75) Inventor: Andrew B. WALDO, Bethesda, MD (US)

(73) Assignee: Decernis, LLC, Washington, DC (US)

(21) Appl. No.: 13/156,478

(22) Filed: Jun. 9, 2011

Related U.S. Application Data
(60) Provisional application No. 61/352,924, filed on Jun. 9, 2010.

(51) Int. Cl. G06Q 10/00

(52) U.S. Cl. 705/7.15

(57) ABSTRACT

A system and method is provided for automated supplier and customer management of technical information and regulatory requirements in a supply chain where materials must meet high standards of health, safety, and performance, including in procurement of food product, food ingredient and food packaging as well as in the manufacture of products that may have hazardous properties may be subjected to rigorous material acceptance policy in procurement of such materials between supplier and customer. The system and method provide for management of procurement projects having project tasks in a manner which permits automated analysis of supplier responses to regulatory and customer requirement inquiries and automated presentation of compliance task status, including highlighting of incomplete tasks for further review and/or analysis to the project manager. The system and method may also provide a clearinghouse to provide supplier information to customers supplied by companies that are themselves customers of an upstream supplier.

### BACKGROUND OF THE INVENTION

The present invention discloses a data processing system to manage and control the technical information passed by suppliers and customers in a supply chain where the materials purchased must meet high standards of health, safety, and performance in the manufacture, processing, and distribution of foods, consumer products and industrial products. In global commerce today, the customer requires that his or her supplier be in compliance with whatever regulatory obligations may apply to the manufacture of the good, but in addition, may demand as a condition of sale that the supplier meet a detailed procurement standard specific to the customer's company and its requirements. For example, a confectionary company will establish one or more procurement standards for all of its suppliers for the purchase of materials used to prepare a package for a candy. One standard might apply to purchased plastics, another to purchased adhesives, and yet another to purchased inks for the label. Along with the development of the procurement standard is commonly a supplier questionnaire that the supplier must complete. The difficulty is that in global manufacturing one company might have hundreds or possibly thousands of suppliers, thousands of purchased materials, changing formulations, and a limited, often manual capability for the company's technical staff to review the responses of its suppliers. With the increasingly complex and dynamic nature of scientific and regulatory developments that might affect the manufacturing, distribution, and sale of a product it is important that the company have the capability to revise and reissue its procurement questionnaires, again causing an influx of responses that the company's technical staff have a limited capability to manage. The present invention discloses a system among other implementations to automate these requirements.

This need for the management of technical information to be provided between supplier and customer in global commerce is not limited to one sector, but is a general problem of manufacturing, distribution, and sale in any process or industry where highly technical procurement standards exist. Examples include but are not limited to foods and food ingredients (see FIG. 3), such as flavors and additives, and food-related uses, such as packaging that might be paper, plastics, labels, etc. (see FIG. 4). The customer needs additional information from its supplier to ensure that the materials purchased will meet all perceived expectations with regard to the performance of the material, its regulation, as well as broader objectives, such as sustainability, environmental friendliness, and energy conservation.

Such examples may also include specific compliance statements required by a customer from its supplier for complex regulations, such as REACH (Registration, Evaluation, Authorization, and Restriction of Chemicals), a restriction imposed in the European Union as well as similar requirements in other countries (see FIG. 1). In other consumer product areas, examples include cosmetics, e.g., the standards applicable to the talc in a cosmetic, or the characteristics of a sun-screen to be included in a lotion, or as above, the packaging of any such products, or to the colors used in a product (see FIG. 2). The manufacturer of a toy would have a similar set of procurement standards. A similar requirement applies to the manufacture of an industrial product to ensure that high standards of performance, safety and sustainability are met as defined by the purchasing entity.

The customer may impose the information requirement on its customer or the customer on the supplier. The supplier may, in certain situations, require that the customer meet its standards before permitting a sale. For example, reputable chemical manufacturers will not sell hazardous substances to a customer unless the customer has met the supplier's procurement standard and often completed its questionnaire.

A downstream retailer may impose requirements on all steps in its supply chain. An association or standard-setting body may collectively impose its technical guidelines on all of its members. Often a market label can be assigned to those manufacturers meeting such a standard. The present invention applies to such instances where the need for a management and control system exist.

Although supply chain management systems exist today and are well known in Prior Art that store information about a supplier and the products purchased they do not include the methods addressed by the present invention. One aspect is the need to examine and manage all of the information relevant to a compliance review to support a decision. It is also common for a supplier or customer to request information by a form on a web-site. This step although helpful simply automates the collection of static information about the requirement. It does not automate the analysis of the information collected, which remains a manual step.

In other words, it would be desirable if the compliance manager could control his or her manufacturing process by defining all of the tasks relevant to an approval of what may be deemed a compliance project, such as the acceptance of the candy package as a whole, including all materials, sub-components, contaminants as well as any documents relating to each. It would also be desirable if the compliance manager could automate the analysis of any supplier's responses to a questionnaire and to compare these responses to a best practice as well as to other responses.

The compliance manager needs in one control system to define all tasks necessary to the compliance approval, have available a composition database that includes the products, components, and raw materials relevant to the task, and further, to have available all of the documents necessary to the approval of a task, such as the material safety data sheet, the submitted questionnaire, a certification letter, a laboratory analysis, etc. Such a task involves the determination of all compliance tasks and their status by raw material, by product, by related task, by supplier, by document with regard to their status, with regard to internal and external changes, and to make comparisons and take further actions. If a similar packaging material can be re-used in another project, it would be desirable to pass an approved project as a set of information, composition data, suppliers and documents, then the validation of new and modified manufacturing processes can be made much more rapidly.

The compliance manager needs to automate the review of the results of a questionnaire. This automation should take into account the regulatory conditions expected, the best practice determinations of the company based on its experience or industry best practices, as well as the performance expectations of the selected materials.

The invention provides for a more effective and timely approval of materials used in a supply chain with the benefits of reduced time, increased accuracy of information being transmitted between supplier and customer.

Other objects, advantages and novel features of the present invention will become apparent from the following detailed description of the invention when considered in conjunction with the accompanying drawings.

### BRIEF DESCRIPTION OF THE DRAWINGS

FIG. 1 illustrates an example of regulatory requirement compliance certification form.

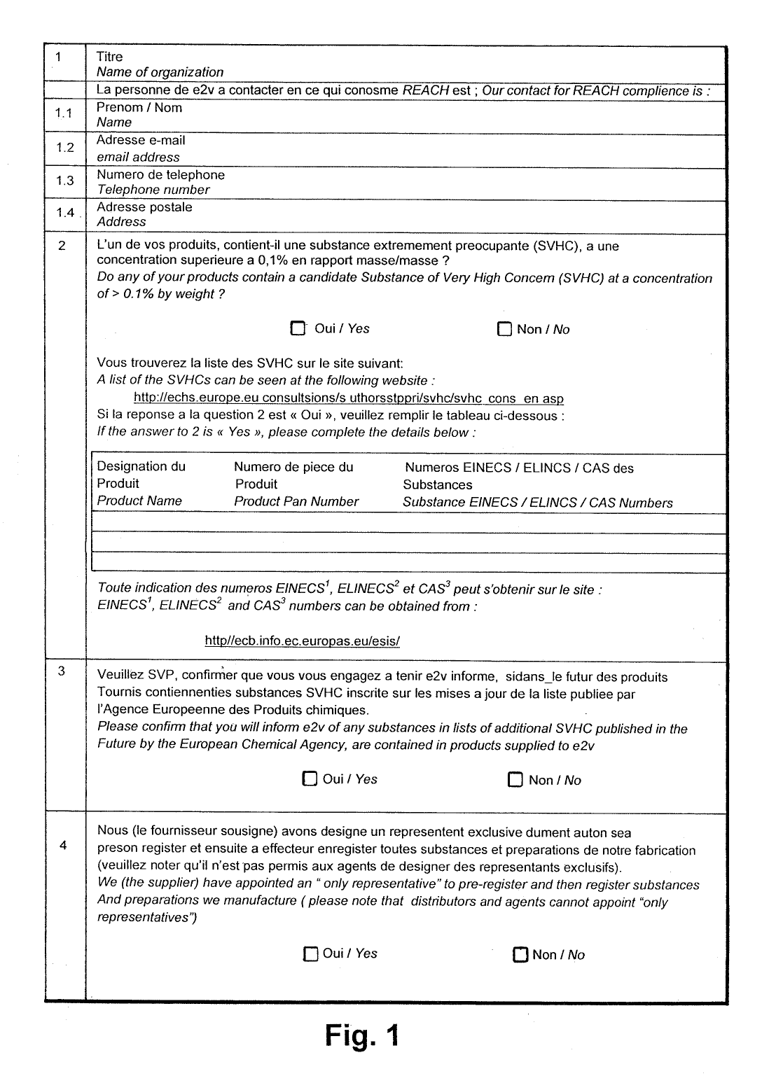

FIG. 2 illustrates an example of restricted substances standards.

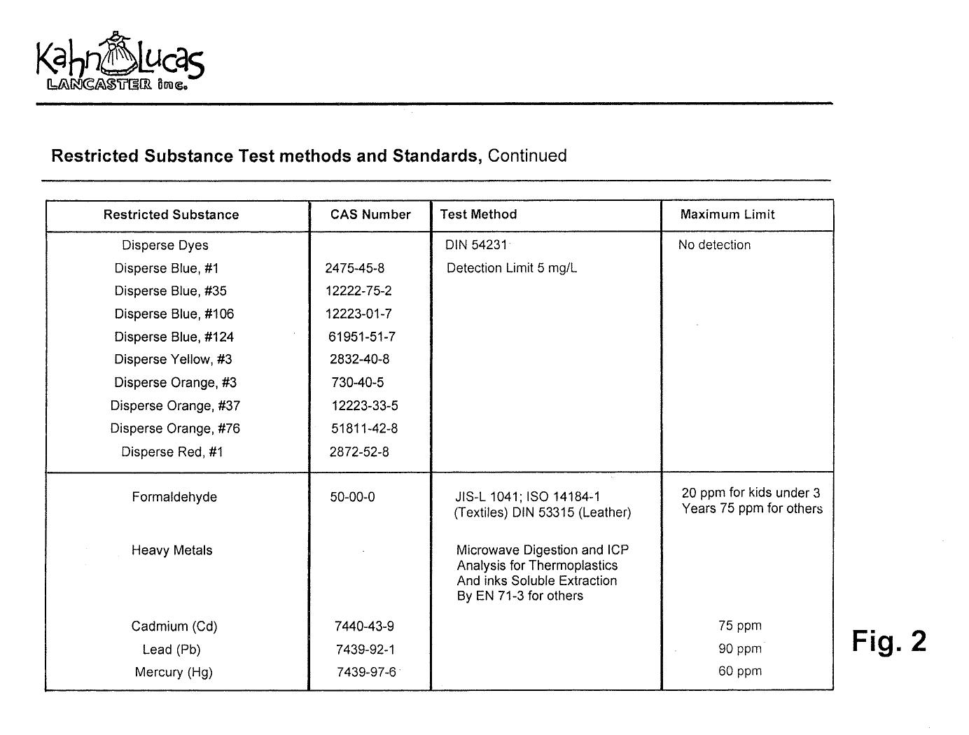

FIG. 3 illustrates an example of technical procurement standards for foods and food ingredients.

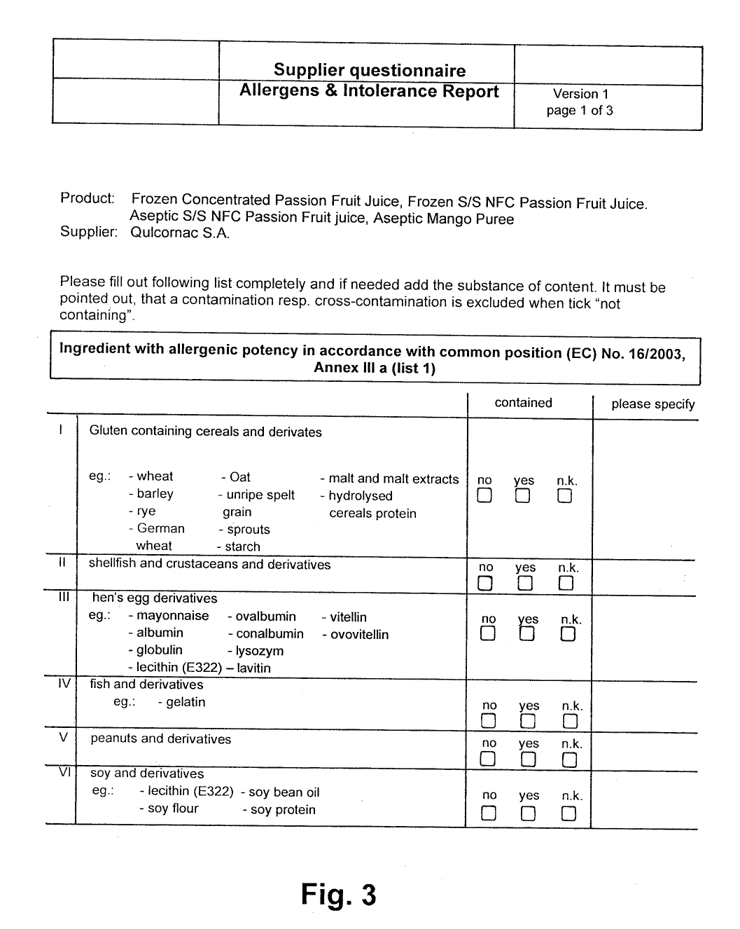

FIG. 4 illustrates an example of technical procurement standards for packaging.

FIG. 5 illustrates a procurement requirement compliance project with task, document and material composition databases in accordance with an embodiment of the present invention.

FIG. 6 illustrates a processing and analysis workflow in an automated compliance management system in accordance with an embodiment of the present invention.

FIG. 7 illustrates a compliance management system project task management status presentation in accordance with an embodiment of the present invention.

FIG. 8 illustrates a portion of a compliance questionnaire form in accordance with an embodiment of the present invention.

FIG. 9 illustrates a portion of a database record containing data extracted from a compliance questionnaire such as that illustrated in FIG. 8.

FIG. 10 illustrates a data mapping form in accordance with an embodiment of the present invention representing a predefined arrangement of questions and the responses of a compliance questionnaire in accordance with an embodiment of the present invention.

FIG. 11 illustrates an example presentation of a result of an automated rules-based analysis of extracted data in accordance with an embodiment of the present invention.

FIG. 12 illustrates an example of rules usable for rules-based analysis of compliance questionnaire responses in accordance with an embodiment of the present invention.

FIG. 13 illustrates an example of a more detailed view of issues identified by an automated rules-based analysis of a compliance questionnaire in accordance with an embodiment of the present invention.

FIG. 14 illustrates presentation of real-time linking of news related to regulatory and other standards based on substance tracking to the product components identified and stored in a composition database of an automated compliance management system in accordance with a further embodiment of the present invention.

### DETAILED DESCRIPTION OF THE INVENTION

An embodiment of the invention for the compliance management system includes a database system and hardware apparatus that includes a composition management system and hardware apparatus to store the product-component-raw material information, a document management system and hardware apparatus to store the related documents, and a database management system and hardware apparatus to store the information about the projects, tasks and associated metadata. The records of the project database include fields to represent the tasks of the compliance project, the product or component relevant to that task, and the document or hyperlink to the document associated with the task.

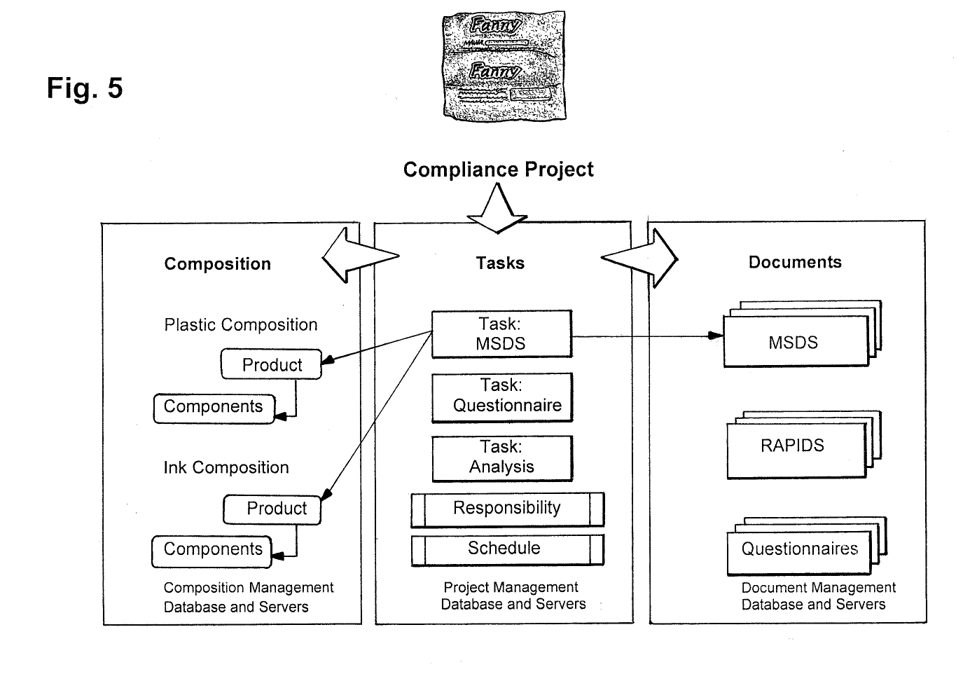

Referring to FIG. 5, as an example, the project is to approve the packaging for the confectionary product, “Fanny”. The compliance manage has identified several tasks necessary for the approval of Fanny. These include: a) the receipt of a material safety data sheet (MSDS) for each component of the package; b) the receipt of an appropriate questionnaire for each component of the package; and c) the representation of the composition of each product in the composition database. In this instance, the compliance manager records the status of a pending task, loads each MSDS when received into the document management system and loads the disclosed composition in the composition management system.

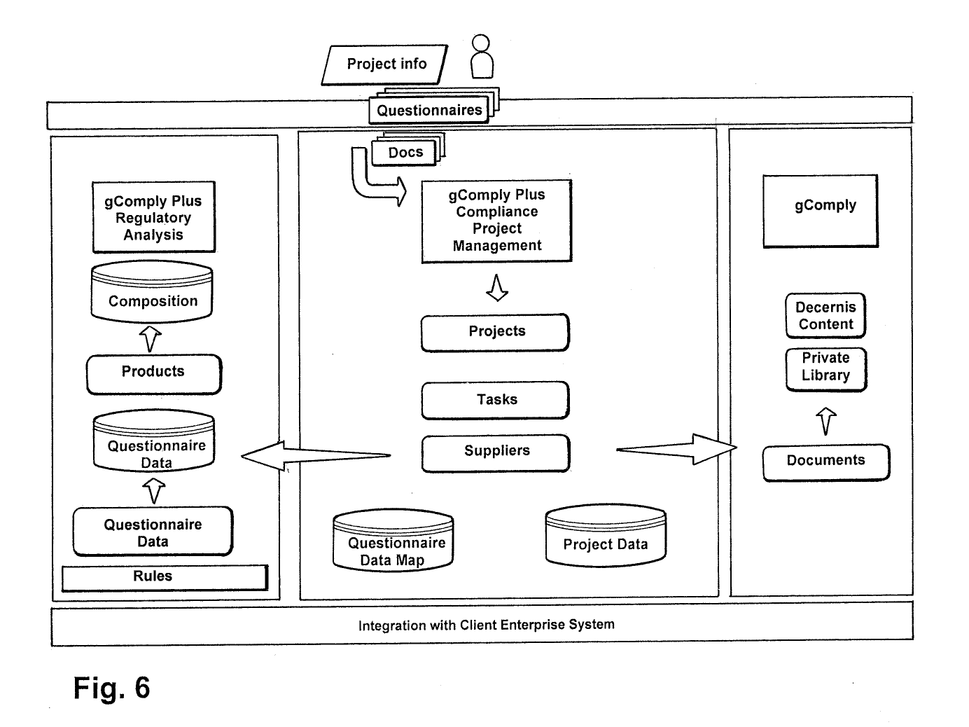

Referring to FIG. 6, the loading of a questionnaire into the system as one embodiment of the present invention causes the system to convert the responses of the questionnaire into data according to a data map that defines the relationship between a question at a given position in the questionnaire to the position where the answers will be found. In one embodiment of the present invention, the extracted responses are then loaded as data into system for regulatory analysis where a rule-based analysis can be performed to analyze the responses against an internal or external best practice established appropriately for that industry and materials.

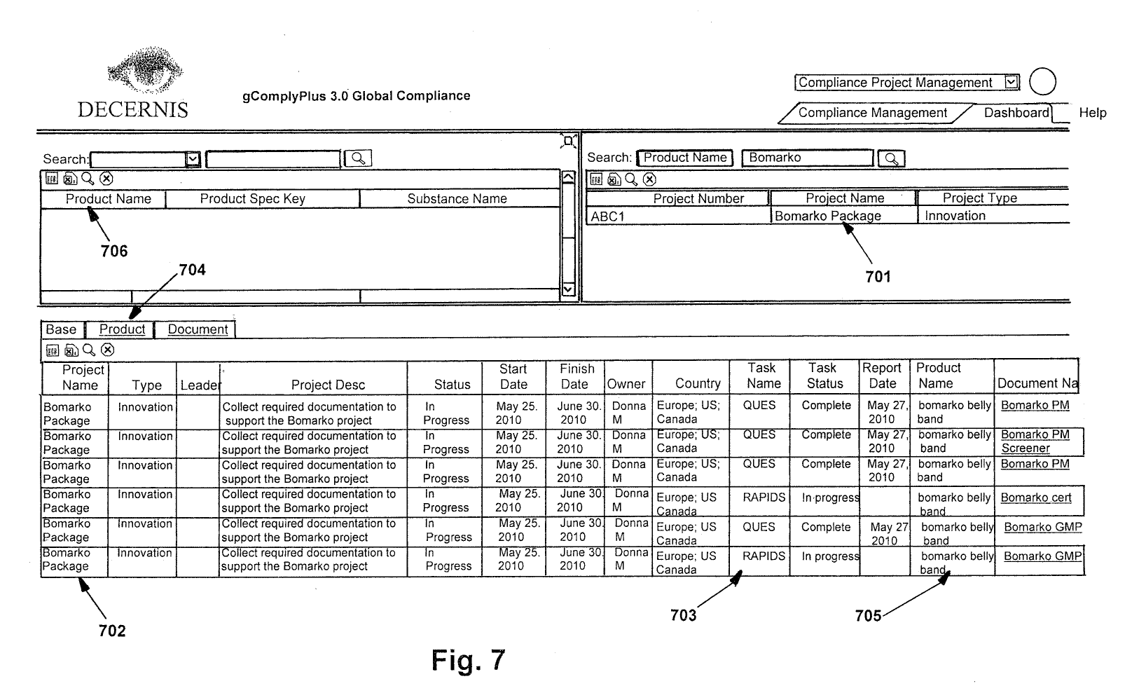

Referring to FIG. 7, an example of a project task management status presentation is shown, in which a project (701) has been selected for review. Each task in the project is listed by project name (702) and task name (703). The related project information may be displayed in a variety of formats by selection of a preferred focus (704), and may include additional information such as listings of the associated product name (705, 706) which may serve as an alternative basis for sorting and display of data for review by the project manager.

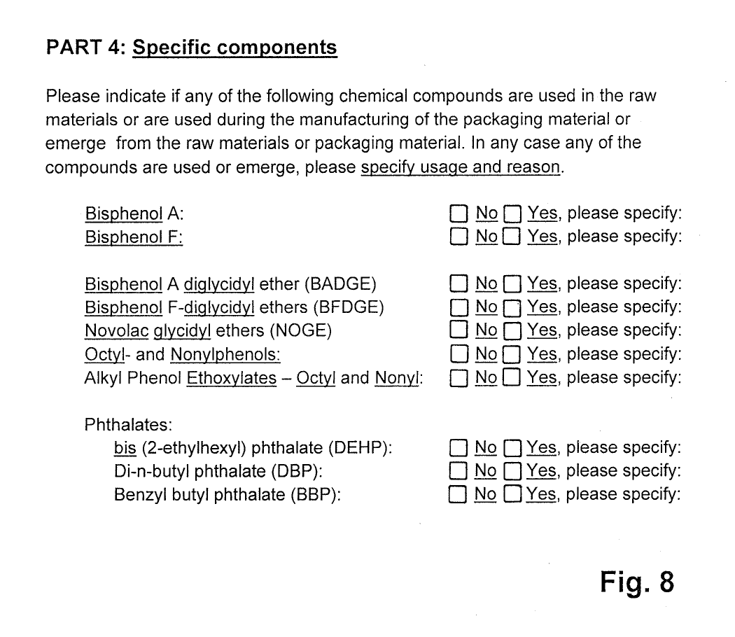

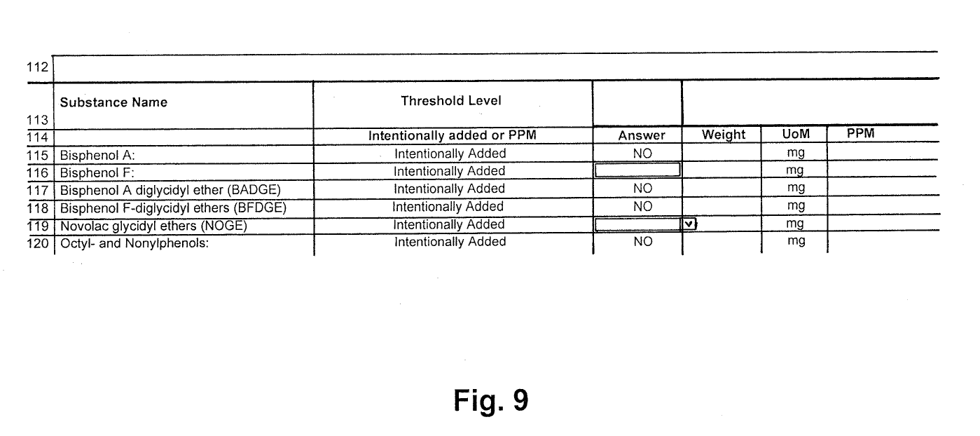

The process of converting a questionnaire to this actionable form is illustrated, beginning in FIG. 8. A questionnaire is prepare with a series of questions, in this case, asking whether particular hazardous substances are included in the raw materials of the product to be purchased for use by the customer in packaging. Referring to FIG. 9, the questionnaire is rendered into a more structured form where the position of the question and answer is determined by some mapping or location convention such as a Cartesian coordinate or row-column address within the questionnaire or by a computational function that will actively return the position of or actual question or answer.

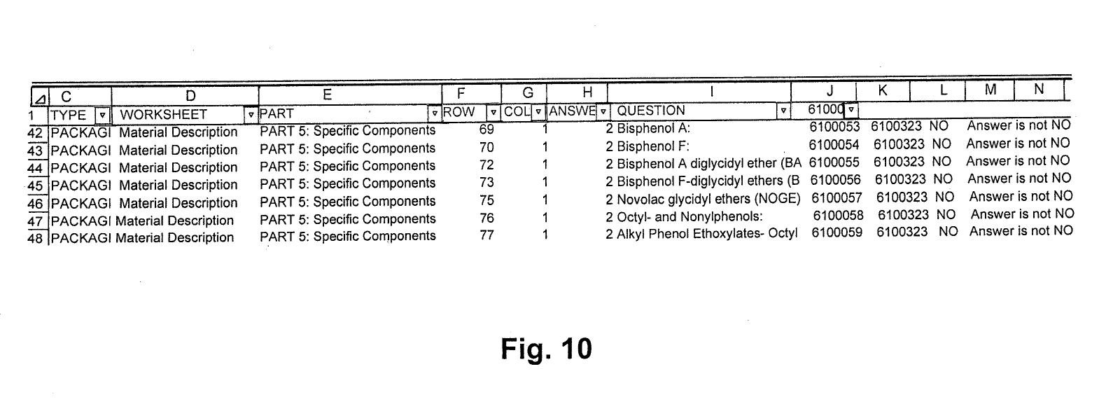

Referring to FIG. 10, in one embodiment of the invention, a data map is prepared that represents the location of the questions and the responses of the questionnaire. In addition, in a further embodiment of the application, a best practice can be established that records the answers expected or error conditions to be identified. This map then allows the responses to be stored as data records.

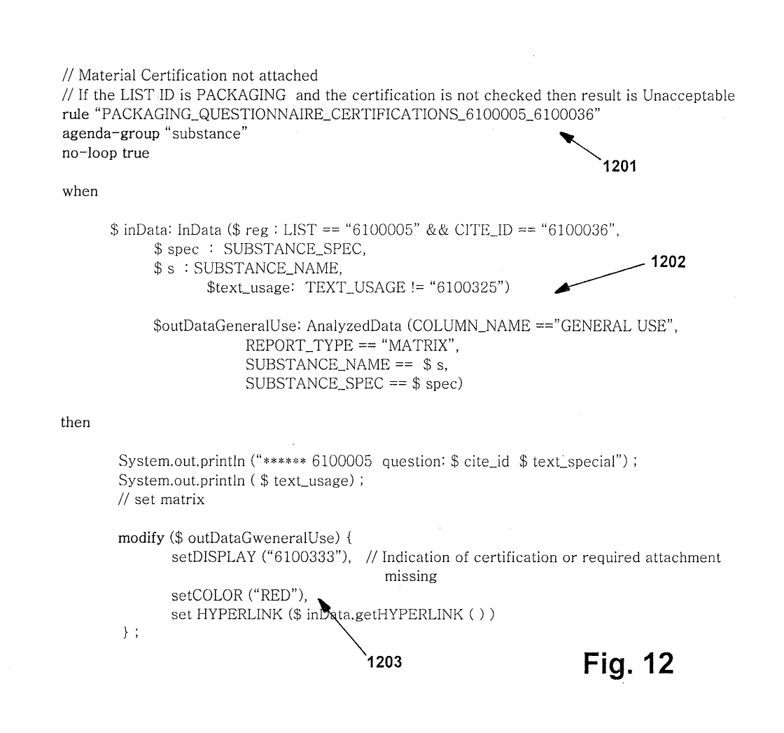

Referring to FIG. 12, in one embodiment of the invention rules can be prepared to analyze the responses of the questionnaire. In this instance, the rule tests whether a certification statement has been made (1201). The rule checks whether the answer for that question is false, that a certification is missing (1202). If so, the consequence of the rule is that the display of the analysis will be colored red and a phrase will appear that a certification is missing with a hyperlink to the page of the questionnaire.

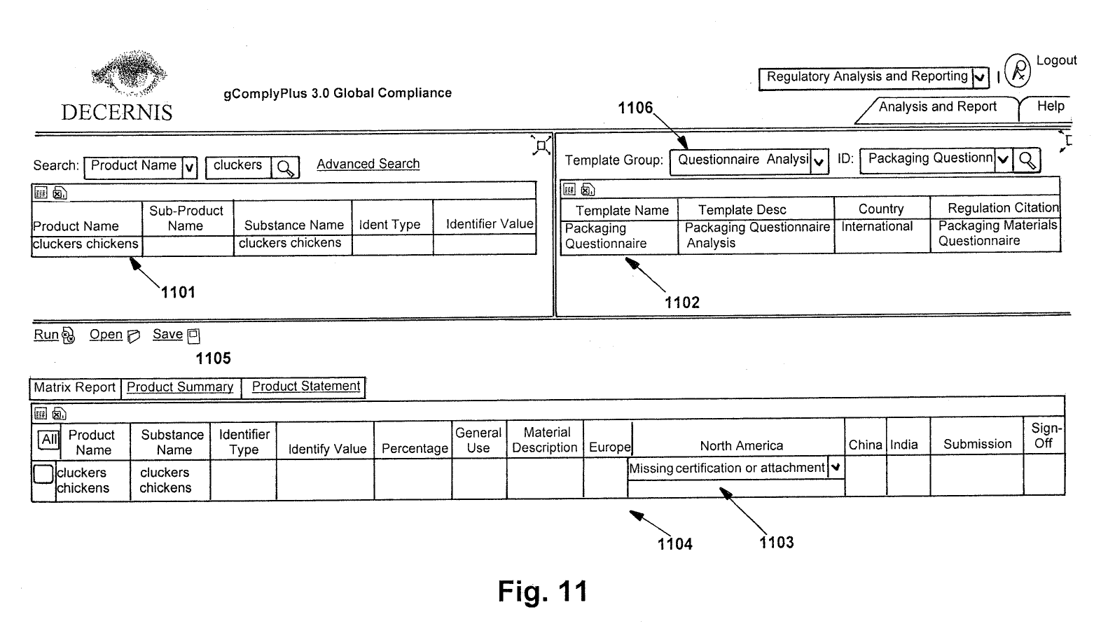

FIG. 11 illustrates the result of the analysis. In this example embodiment of the invention the display shows a management console where the user can search for a product, in this case, “cluckers chickens,” a toy (1101). In alternative embodiments of the application, the analysis would be produced automatically and delivered via a network to one or more applications, mobile users, servers via a variety of different protocols with and without human intervention. The users may be applications or human beings. In the depiction the user then selects a template as depicted in the upper right hand frame of the system (1106) to run relevant to the product and intended analysis (1102). The answer returned from the analysis in the lower frame (1105) is that two problems exist with the responses of the questionnaire, a certification is missing and a more complex analysis suggests that the use of the plastic in this product should be reviewed based on the responses of the questionnaire (1103). A hyperlink opens the actual page of the questionnaire in one embodiment (1104) to allow the reviewer to make a determination.

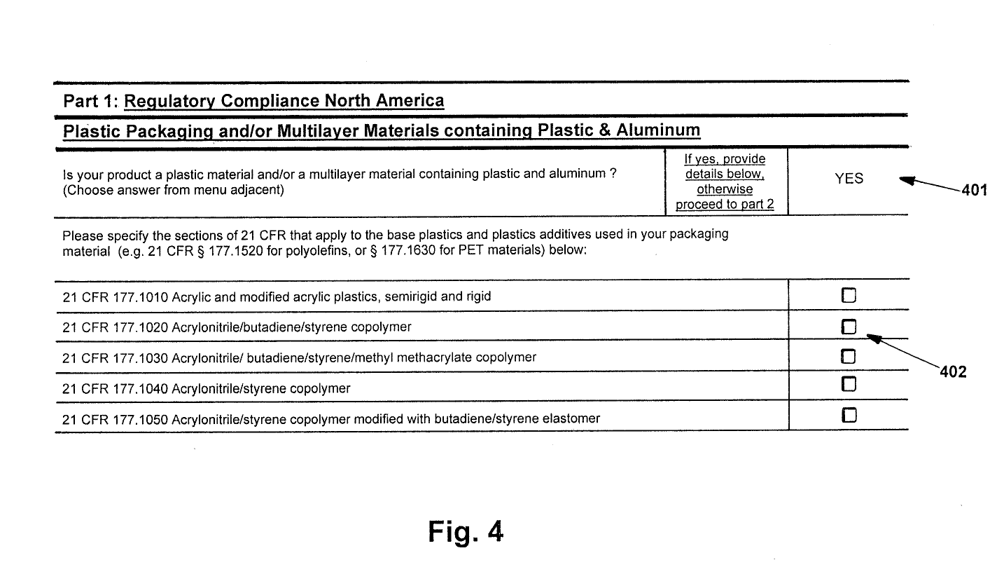

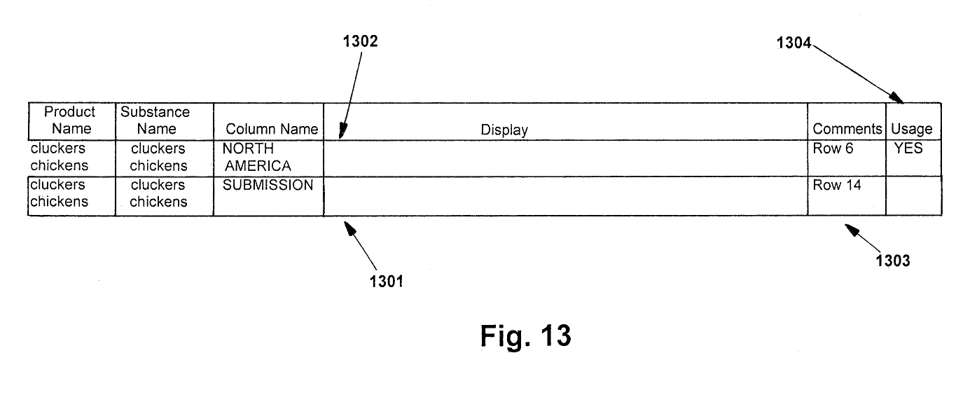

A more detailed view of the problems of the supplier's response is available in one embodiment of the invention (see FIG. 13). In one instance, the supplier has mistakenly not completed the questionnaire's required certification (1301), found at Row 14 of the questionnaire's SUBMISSION section. In another instance, the supplier has answered yes to the question whether FDA has approved the material specifically (see FIG. 4). At 401 the respondent has answered yes, but has failed to indicate whether FDA approves the plastic (402). This failure may not be conclusive of the outcome but warrants a closer review.

In this manner and with different embodiments the present invention reduces time, increases accuracy, and makes transaction control more effective between supplier and customer.

A number of services may be added to the control system in different embodiments. One example of such an embodiment is a third-party clearinghouse service that allows customers to receive information relevant to a question from upstream suppliers where the information may be proprietary and disclosed only to the downstream customer but not to the immediate supplier of that customer. In such an embodiment, the supplier to the customer can answer questions relating to material acceptance that may be obtained through the third party service or from an upstream supplier. The supplier and customer can also act in a networked business-to-business exchange where the review of materials occurs in an automated manner. The receiving party can add analytical services, such as trend analysis, comparison of products or components or time-series analyses of supply chain actions. For instance, a customer may wish to know all projects or products within the company that use Bisphenol A because of the concerns raised about its toxicological effects. Being able to single out all activity within the company affected by a single component or raw material is a significant benefit in supply chain management. The present invention allows additional structure, formality, accuracy and insight into supply chain management.

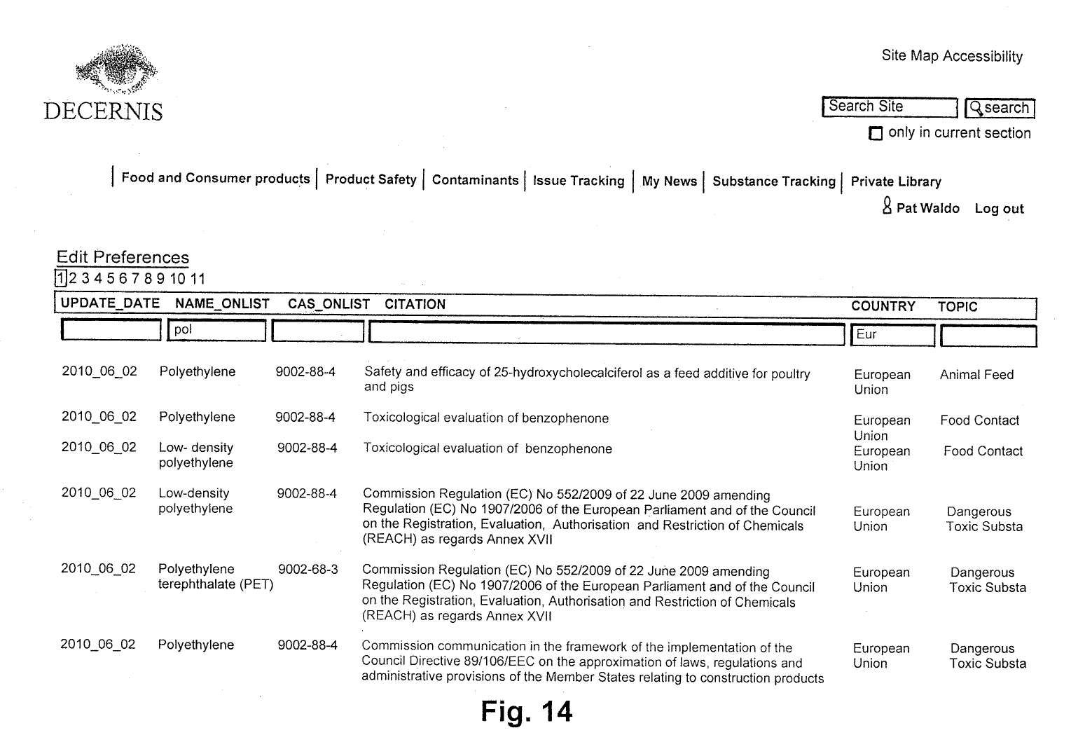

In a further embodiment of the present invention, an aggregator News service can be linked to the supplier's disclosures to the customer. Referring to FIG. 14, a News service provides substance tracking. The product components stored in the composition database of the present invention can be linked to the substances contained within discovered news articles in real-time. As a result a News aggregator service providing substance tracking can be linked to supplier and customer review in such a manner that the highly dynamic developments in food and consumer product safety—for instance a new toxicological study or a newly proposed regulation—can be related to the materials flowing being used in manufacturing process.

The foregoing disclosure has been set forth merely to illustrate the invention and is not intended to be limiting. Because modifications of the disclosed embodiments incorporating the spirit and substance of the invention may occur to persons skilled in the art, the invention should be construed to include everything within the scope of the appended claims and equivalents thereof.

What is claimed is:

1. A method for automated management of technical information in a procurement requirement compliance system operated on a networked computer, comprising the steps of:
identifying at least one task associated with completion of a procurement requirement compliance project;
storing the at least one task in a first database associated with the networked computer;
receiving at the networked computer procurement requirement compliance technical information associated with the at least one task from an information supplying party, wherein the procurement requirement compliance technical information includes supplying party responses to requirement compliance questions arranged in a predefined format;
extracting data from the received procurement requirement compliance technical information using an automated data extraction routine, wherein the automated data extraction routine identifies and extracts data from the received procurement requirement compliance technical information based on a mapping of the information received from supplying party to a location of the data in the predefined format;
populating the extracted data in at least one of a material composition database, a document management database and the first database;
analyzing the extracted data populated in at least one of the system databases with one of a database query and automated function which identifies at least one of a compliance status and a completion status of each of the at least one tasks, wherein the one of query and automated function is based on comparison of at least one element of the extracted data to at least one of a regulatory requirement, industry standard, information request, and a requirement at least one of a customer and supplier; and
making available in human-readable form information on the status of each of the at least one task, wherein any non-compliant or uncompleted task is presented in a manner identifying a need for further task management review.

2. The method of claim 1, wherein
the procurement requirement compliance technical information received from the supplying party is provided in response to a questionnaire in the predefined format containing at least one question requiring a supplying party statement of compliance with the at least one of a regulatory requirement, industry standard and a customer requirement.

3. The method of claim 2, wherein
the information on the status of each of the at least one task made available in human-readable form includes at least one hyperlink to source documentation associated with the supplying party response to the questionnaire.

4. The method of claim 3, wherein
the procurement requirement compliance system includes extracted data associated with compliance with at least one of food, food ingredient, manufacture, processing, distribution, and transport of an article, packaging and chemical requirement compliance, and
the at least one task associated with completion of the procurement requirement compliance project includes at least one of an obtaining material composition information, obtaining Material Safety Data Sheet information, obtaining properties of a component, ingredient, commodity, and product, and obtaining supplying party response to the questionnaire.

5. The method of claim 1, wherein
the information on the status of each of the at least one task is made available to an automated incomplete task management system for providing automated identification of incomplete responses to the supplying party, the incomplete responses including responses for which no information is provided by the supplying party and responses which do not provide sufficient information to ascertain requirement compliance.

6. The method of claim 1, wherein
the procurement requirement compliance technical information received from the supplying party is provided from at least one of a central clearinghouse third-party service and a supplier to the supplying party and obtained by a dynamic link to information that may be obtained by at least one of a dynamic link, query and automated function of the one of the third party service and the supplier to the supplying party.

7. A procurement requirement compliance system for automated management of technical information, comprising:
a networked computer, the network computer being configured to
identify at least one task associated with completion of a procurement requirement compliance project;
store the at least one task in a first database associated with the networked computer;
receive at the networked computer procurement requirement compliance technical information associated with the at least one task from an information supplying party, wherein the procurement requirement compliance technical information includes supplying party responses to requirement compliance questions arranged in a predefined format;
extract data from the received procurement requirement compliance technical information using an automated data extraction routine, wherein the automated data extraction routine is configured to identify and extract data from the received procurement requirement compliance technical information based on a mapping of the information received from supplying party to a location of the data in the predefined format;
populate the extracted data in at least one of a material composition database, a document management database and the first database;
analyze the extracted data populated in at least one of the system databases with one of a database query and automated function which identifies at least one of a compliance status and a completion status of each of the at least one tasks, wherein the one of query and automated function is based on comparison of at least one element of the extracted data to at least one of a regulatory requirement, industry standard, information request, and a requirement for one of a customer and supplier; and
the extracted data populated in at least one of the system databases with an automated rules-based routine configured to identify at least one of a compliance status and a completion status of each of the at least one tasks, wherein the automated rules-based routine is based on comparison of at least one element of the extracted data to at least one of a regulatory requirement, industry standard and a customer requirement; and
make available in human-readable form information on the status of each of the at least one task, wherein the system is configured to present any non-compliant or uncompleted task in a manner identifying a need for further task management review.

8. The system of claim 7, wherein
the procurement requirement compliance technical information received from the supplying party is in a predefined format associated with a questionnaire containing at least one question which requires a supplying party statement of compliance with the at least one of a regulatory requirement, industry standard and a customer requirement.

9. The method of claim 8, wherein
the information on the status of each of the at least one task made available in human-readable form includes at least one hyperlink to source documentation associated with the supplying party response to the questionnaire.

10. The system of claim 9, wherein
the procurement requirement compliance system includes extracted data associated with compliance with at least one of food, food ingredient, manufacture, processing, distribution, and transport of an article, packaging and chemical requirement compliance, and
the at least one task associated with completion of the procurement requirement compliance project includes at least one of an obtaining material composition information, obtaining Material Safety Data Sheet information, obtaining properties of a component, ingredient, commodity, and product, and obtaining supplying party response to the questionnaire.

11. The system of claim 7, wherein
the procurement requirement compliance system is configured to provide information on the status of each of the at least one task to an automated incomplete task management system configured to provide automated identification of incomplete responses to the supplying party, the incomplete responses including responses for which no information is provided by the supplying party and responses which do not provide sufficient information to ascertain requirement compliance.

12. The system of claim 7, wherein
the procurement requirement compliance technical information received from the supplying party is provided from at least one of a central clearinghouse third-party service and a supplier to the supplying party and obtained by a dynamic link to information that may be obtained by at least one of a dynamic link, query and automated function of the one of the third party service and the supplier to the supplying party.
